(19) United States
(12) Patent Application Publication
(10) Pub. No.: US 2014/0082929 A1
(43) Pub. Date: Mar. 27, 2014

(54) METHOD FOR MANUFACTURING ROTATING DEVICE

(71) Applicant: SAMSUNG ELECTRO-MECHANICS JAPAN ADVANCED TECHNOLOGY CO., LTD., Fujieda City (JP)

(72) Inventors: Mitsuhiro AONO, Fujieda City (JP); Kenji NISHIHARA, Yaizu City (JP)

(73) Assignee: SAMSUNG ELECTRO-MECHANICS JAPAN ADVANCED TECHNOLOGY CO., LTD., Fujieda City (JP)

(21) Appl. No.: 14/035,769

(22) Filed: Sep. 24, 2013

(30) Foreign Application Priority Data
Sep. 25, 2012 (JP) 2012-211518

(51) Int. Cl. G11B 33/14; G11B 5/10

(52) U.S. Cl. CPC G11B 33/1446; G11B 5/102
USPC 29/603.03

(57) ABSTRACT

A rotating device includes a hub on which a magnetic recording disk is to be mounted, and a base that supports the hub in a freely rotatable manner. When at least either one of the base and the hub is referred to as a work-piece, a method for manufacturing the rotating device includes a forming step for forming the work-piece, a blowing step for blowing the formed work-piece with solid grains, a cleaning step for cleaning the work-piece blown by the grains using a cleaning fluid, an assembling step for assembling the rotating device using the cleaned work-piece. The grains have a property of vaporizing in the cleaning step or being soluble with the cleaning fluid therein.

### BACKGROUND OF THE INVENTION

1. Field of the Invention

The present invention relates to a method for manufacturing a rotating device.

2. Description of the Related Art

An example rotating device is a disk drive device like a hard disk drive. Recently, such a device is becoming downsized and increasing its capacity, and a model that is 2.5 inch type and has a capacity of 2.0 TB or so has been released to the market. Because of such a tendency, conventional disk drive devices that have been mainly loaded in a desktop computer are now loaded in various electronic devices, such as a laptop computer and a recording device. JP 2011-123984 A discloses a method for manufacturing such a disk drive device. A further capacity increase is necessary for disk drive devices due to a popularization of large-capacity contents like high-definition television motion images.

A technology of making the pitch of recording tracks narrower and allowing a magnetic head to become closer to the surface of a magnetic recording disk is known to realize an increase of the capacity.

According to disk drive devices, foreign materials sticking to components like a hub and a base may be taken out due to vibration, etc., and may stick to the disk. Such foreign materials may stick through a process of vaporization and re-condensation, etc. The foreign materials sticking to the disk may cause a read/write error.

When the pitch of the recording tracks becomes narrower in order to increase the capacity, foreign materials become large relative to such a pitch. This remarkably increases an adverse effect to a read/write operation. Moreover, when the gap between the magnetic head and the disk surface becomes narrower, the sticking foreign materials become likely to disturb a recording/playing head, and thus the adverse effect to the read/write operation becomes likewise remarkable. That is, minute or a little amount of foreign materials that are allowable according to the conventional technologies may negatively affect to an operation when a capacity increase is accomplished.

According to the above-explained conventional manufacturing method, it is possible to reduce the foreign materials sticking to the components and to increase the cleanness. However, in order to accomplish a further capacity increase of disk drive devices, there is always a need for a further higher cleanness. According to a conventional cleaning technology, it is necessary to increase a cleaning time to increase the cleanness. This increases manufacturing costs, disturbing a timely manufacturing.

The same is true of other kinds of rotating devices other than disk drive devices.

The present invention has been made in view of the aforementioned circumstances, and it is an objective of the present invention to provide a method for manufacturing a rotating device to reduce foreign materials sticking to components of a rotating device while avoiding an increase in manufacturing time of the rotating device.

### SUMMARY OF THE INVENTION

To accomplish the above objective, a first aspect of the present invention provides a method for manufacturing a rotating device, the rotating device comprising a hub on which a recording disk is to be mounted, and a base that supports the hub in a freely rotatable manner, when at least one of the base and the hub is referred to as a work-piece, the method including: a forming step for forming a work-piece; a blowing step for blowing the formed work-piece with solid grains; a cleaning step for cleaning the work-piece blown by the grains using a cleaning fluid; and an assembling step for assembling the rotating device using the cleaned work-piece, in which the grains have a property of vaporizing in the cleaning step or being soluble with the cleaning fluid therein.

According to this aspect, it becomes possible to reduce the amount of foreign materials sticking to a work-piece.

To accomplish the above objective, a second aspect of the present invention provides a method for manufacturing a rotating device, the rotating device comprising a hub on which a recording disk is to be mounted, and a base that supports the hub in a freely rotatable manner, when at least one of the base and the hub is referred to as a work-piece, the method including: a forming step for forming a work-piece; a blowing step for blowing the formed work-piece with solid grains that contain sodium hydrogen carbonate; a cleaning step for cleaning the work-piece blown by the grains using a cleaning fluid; and an assembling step for assembling the rotating device using the cleaned work-piece.

To accomplish the above objective, a third aspect of the present invention provides a method for manufacturing a rotating device, the rotating device comprising a hub on which a recording disk is to be mounted, and a base that supports the hub in a freely rotatable manner, when at least one of the base and the hub is referred to as a work-piece, the method including: a forming step for forming a work-piece; a blowing step for blowing the formed work-piece with solid grains that are formed of a softer material than the work-piece; a cleaning step for cleaning the work-piece blown by the grains using a cleaning fluid; an assembling step for assembling the rotating device using the cleaned work-piece; and a collecting step for collecting the blown grains to the work-piece in the blowing step, in which the grains have a property of vaporizing in the cleaning step or being soluble with the cleaning fluid therein.

Any combinations of the above-explained structural elements and a mutual replacement thereof and expressions between a method, a device, and a system, etc., are also effective as an aspect of the present invention.

According to the present invention, it becomes possible to reduce foreign materials sticking to the components of a rotating device while avoiding an increase in manufacturing time thereof.

### BRIEF DESCRIPTION OF THE DRAWINGS

FIG. 1A is a top view illustrating a rotating device manufactured through a manufacturing method according to an embodiment of the present invention;

FIG. 1B is a side view illustrating the rotating device manufactured through the manufacturing method of the embodiment;

FIG. 2 is a cross-sectional view taken along a line A-A in FIG. 1A;

FIG. 3 is an exemplary manufacturing step diagram illustrating a step for manufacturing a hub;

FIG. 4 is an exemplary diagram illustrating a blowing step in FIG. 3;

FIG. 5 is an exemplary diagram illustrating a first contact step in FIG. 3;

FIG. 6 is a diagram illustrating cleanness when a hub was cleaned by a bath alone and cleanness when a hub was cleaned by three bathes individually;

FIG. 7 is a diagram illustrating a distribution of cleanness when a hub is cleaned in various conditions;

FIG. 8A is an exemplary diagram illustrating how a hub is irradiated with ultrasound through a cleaning fluid;

FIG. 8B is an exemplary diagram illustrating how a hub is irradiated with ultrasound through a cleaning fluid;

FIG. 8C is an exemplary diagram illustrating how a hub is irradiated with ultrasound through a cleaning fluid; and

FIG. 9 is an exemplary diagram illustrating a second contact step and a drying step in FIG. 3.

### DETAILED DESCRIPTION OF THE PREFERRED EMBODIMENTS

In the following explanation, the same or equivalent structural element, member, and step illustrated in respective figures will be denoted by the same reference numeral, and the duplicated explanation thereof will be omitted accordingly. The dimension of a member in each figure is enlarged or scaled-down as needed to facilitate understanding to the present invention. A part of the member not important to explain an embodiment of the present invention will be omitted in each figure.

A rotating device manufactured through a manufacturing method according to an embodiment of the present invention includes a hub on which a recording disk is to be mounted, and a base that supports the hub in a freely rotatable manner. Such a rotating device includes a disk drive device that rotates and drives a magnetic recording disk, in particular, a hard disk drive.

First of all, an explanation will be given of a background to reach an embodiment of the present invention. The inventors of the present invention reached a knowledge that in accordance with a remarkable increase in capacity of disk drive devices to, for example, 500 GB to 1 TB per a disk, it is necessary to reduce the amount of the element in a cutting fluid left on a structural component to be equal to or smaller than 1/20 times as much as the conventional technology. That is, when the cleanness of the conventional structural component is maintained as it is, a signal reading/writing head may run on foreign materials sticking to the surface of a disk, which may disturb the reading/writing of a recording signal. Moreover, the inventors of the present invention keenly studied the element in the cutting fluid sticking to the structural component of a disk drive device, and found that the element of the cutting fluid left on the structural component contains, in addition to carbon hydride, fatty acid ester, and fatty acid produced by hydrolysis of this fatty acid ester, and when fatty acid ester and fatty acid (hereinafter, referred to as “denatured material”, etc.) are left on the structural component of a disk drive device, those may stick to the surface of a recording disk through dispersion, vaporization/re-condensation, and thus it bothers an increase in the capacity of the disk drive device. The inventors of the present invention also recognized that when it is attempted to eliminate the denatured materials, etc., left on the structural component through a conventional cleaning technology, it takes a long time for cleaning.

In general, a structural component of disk drive devices is formed of a metal material having at least partially undergone cutting and machining. For example, a hub is formed of a metal material, and at least a part corresponding to the center hole of a disk and a part contacting the periphery thereof are subjected to a cutting work to improve the dimensional precision. In order to reduce the work time of this cutting work or to improve the dimensional precision, the metal material is added with, for example, so-called free-cutting elements, such as Mn, S, Te, and Pb. The inventors of the present invention found that when a metal material containing a free-cutting element is cut, the free-cutting element, etc., may stick to a cut surface as a micro protrusion, and when this micro protrusion is peeled and moved to the disk surface, it may be a cause for the above-explained defect. The inventors of the present invention also recognized that when it is attempted to eliminate such a micro protrusion on the cut surface through a conventional cleaning technology, it takes a long time for cleaning. Based on the above-explained knowledge, the inventors of the present invention reach an embodiment of the present invention below.

According to the manufacturing method of this embodiment, solid grains are blown (e.g., sprayed or blasted) to the structural component of the rotating device. Hence, carbon hydride (including a denatured material of carbon hydride, etc.), micro protrusions of the free-cutting element, and other foreign materials sticking to the structural component can be blown off. Alternatively, even if such foreign materials cannot be blown off, the sticking force between the foreign materials and the structural component can be weakened, facilitating the reduction of the foreign materials in the following steps. Moreover, according to the manufacturing method of this embodiment, the structural component blown with the grains is cleaned by a cleaning fluid. This reduces the amount of foreign materials sticking to the structural component. When the grain is soluble with the cleaning fluid, the grains sticking to the structural component can be also eliminated through the cleaning. When those processes are performed prior to an actual cleaning, a desired cleanness can be obtained with a relatively short actual cleaning time.

(Rotating Device)

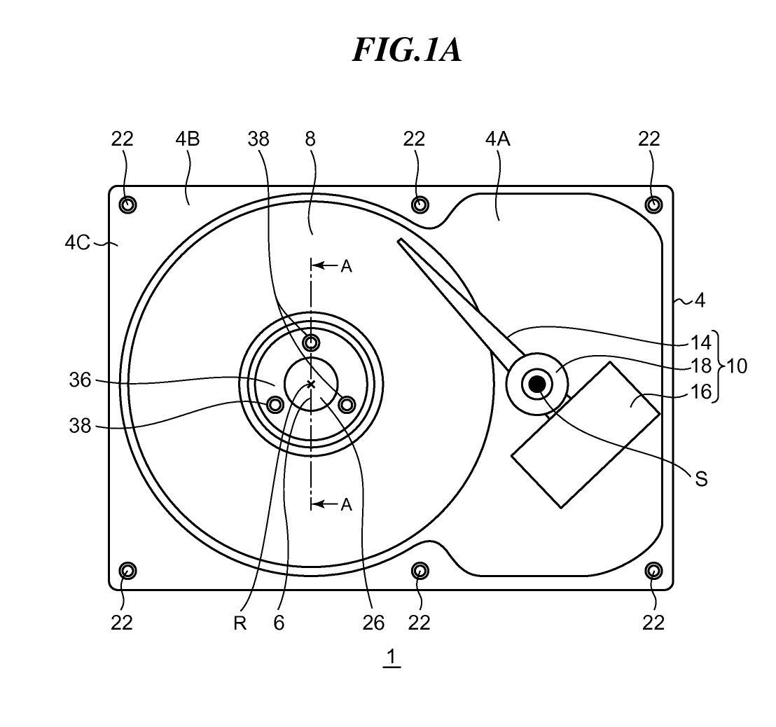

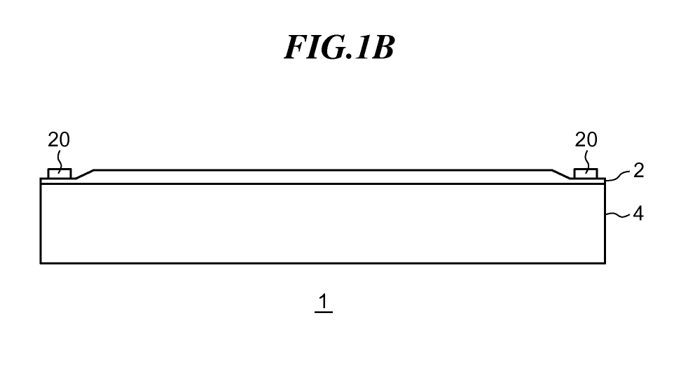

FIGS. 1A and 1B are top view and side view of a rotating device 1 manufactured through the manufacturing method of this embodiment. FIG. 1A is a top view of the rotating device 1. In FIG. 1A, in order to illustrate the interior of the rotating device 1, a condition having a top cover 2 detached is illustrated. The rotating device 1 includes a base 4, a rotor 6, a magnetic recording disk 8, a data reader/writer 10, and the top cover 2. The rotating device 1 is a hard disk drive that rotates the magnetic recording disk 8.

The following explanation will be given with a definition that a side at which the rotor 6 is mounted relative to the base 4 is an upper side.

The structure of the rotating device 1 explained below is merely an example, and is not limited to the following structure explained below as long as the same advantageous effect can be obtained through the manufacturing method of the present invention.

The magnetic recording disk 8 is, for example, a 2.5-inch magnetic recording disk made of glass and having a diameter of 65 mm, and the diameter of the center hole is 20 mm and the thickness is 0.65 mm.

The magnetic recording disk 8 is to be mounted on the rotor 6, and rotates together with a rotation of the rotor 6. The rotor 6 is attached to the base 4 through a bearing unit 12 that is not illustrated in FIG. 1A in a manner freely rotatable.

The base 4 is formed of an aluminum alloy having undergone a die-cast molding. The base 4 includes a bottom portion 4A that forms a bottom of the rotating device 1, and an outer circumferential wall 4B that is formed along the outer circumference of the bottom portion 4A so as to surround the mounting space for the magnetic recording disk 8. For example, six screws 22 are provided in a top face 4C of the outer circumferential wall 4B.

The data reader/writer 10 includes a recording/playing head (unillustrated), a swing arm 14, a voice coil motor 16, and a pivot assembly 18. The recoding/playing head is attached to the tip of the swing arm 14, records data in the magnetic recording disk 8, or reads the data therefrom. The pivot assembly 18 supports the swing arm 14 in a swingable manner to the base 4 around a head rotating shaft S. The voice coil motor 16 allows the swing arm 14 to swing around the head rotating shaft S to move the recording/playing head to a desired location over the top face of the magnetic recording disk 8. The voice coil motor 16 and the pivot assembly 18 are configured by a conventionally well-known technology of controlling the position of a head.

FIG. 1B is a side view of the rotating device 1. The top cover 2 is fastened to the top face 4C of the outer circumferential wall 4B of the base 4 using six screws 20. The six screws 20 correspond to the six screw holes 22, respectively. In particular, the top cover 2 and the top face 4C of the outer circumferential wall 4B are fastened with each other so as not to cause a leak to the interior of the rotating device 1 from the joined portion therebetween.

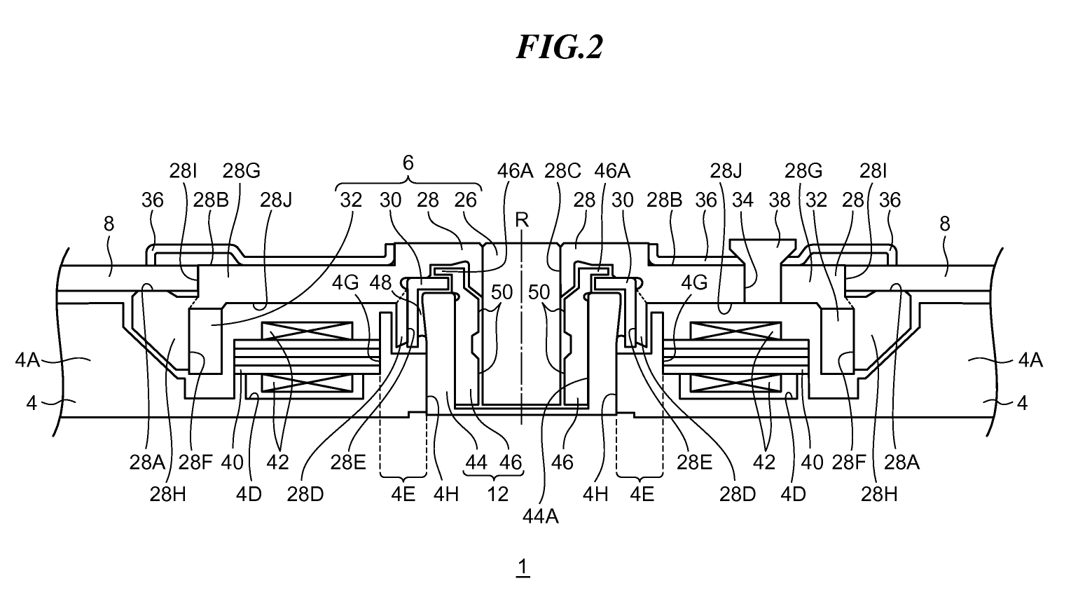

FIG. 2 is a cross-sectional view taken along a line A-A in FIG. 1A. The rotating device 1 further includes a laminated core 40 and coils 42. The laminated core 40 includes an annular part and twelve salient poles extending outwardly in the radial direction (i.e., a direction orthogonal to a rotation axis R) from the annular part, and is fastened to an upper face 4D of the base 4. The laminated core 40 is formed by, for example, laminating four thin magnetic steel sheets and integrating those together by caulking. An insulative coating like electrodeposition coating or powder coating is applied to the surface of the laminated core 40. The coil 42 is wound around each salient pole. When a three-phase drive current of a substantially sinusoidal wave is allowed to flow through each coil 42, drive magnetic fluxes are produced along the salient poles. An annular wall 4E around the rotation axis R of the rotor 6 is provided on the upper face 4D of the base 4. The laminated core 40 is bonded and fastened to an outer circumference 4G of the annular wall 4E of the laminated core 40 by press-fitting or loose fitting.

A through-hole 4H is formed in the base 4 along the rotation axis R of the rotor 6. The bearing unit 12 includes a housing 44 and a sleeve 46, and supports the rotor 6 in a freely rotatable manner with respect to the base 4. The housing 44 is formed in a cup shape with a bottom that has a cylindrical part and a bottom joined together. That is, the housing 44 has a recess 44A around the rotation axis R and opened upwardly. The housing 44 is fastened to the through-hole 4H of the base 4 by a bond with the bottom of the housing 44 being directed downwardly.

The sleeve 46 is a cylindrical member fitted in the recess 44A of the housing 44 and bonded and fastened thereto. A flared portion 46A that extends outwardly in the radial direction is formed at the upper end of the sleeve 46. This flared portion 46A restricts the motion of the rotor 6 in the axial direction together with a thrust member 30.

A shaft 26 is retained in the sleeve 46. A lubricant 48 is filled between the shaft 26, the hub 28 and the thrust member 30 that are a part of the rotor 6 and the bearing unit 12 that is a part of the stator.

A pair of radial dynamic pressure grooves 50 in, for example, a herringbone shape and distant from each other in the axial direction are formed in the inner circumference of the sleeve 46. A first thrust dynamic pressure groove (unillustrated) in, for example, a herringbone shape is formed in the lower face of the thrust member 30 facing with the upper face of the housing 44. A second thrust dynamic pressure groove (unillustrated) in, for example, a herringbone shape is formed in the upper face of the thrust member 30 facing with the lower face of the flared portion 46A. When the rotor 6 rotates, the rotor 6 is supported in the radial direction and in the axial direction by dynamic pressures generated by those dynamic pressure grooves to the lubricant 48.

The pair of radial dynamic pressure grooves in a herringbone shape may be formed in the shaft 26. Moreover, the first thrust dynamic pressure groove may be formed in the upper face of the housing 44, and the second thrust dynamic pressure groove may be formed in the lower face of the flared portion 46A.

The rotor 6 includes the shaft 26, the hub 28, the thrust member 30, and a cylindrical magnet 32. The hub 28 is formed of a ferrous material like SUS 430 F with a soft magnetism. The hub 28 is formed by cutting the ferrous material, and is formed in a predetermined shape like a substantially cup shape.

In order to enhance the free-cutting property, the ferrous material of the hub 28 is added with elements, such as Mn, S, Te, and Pb. The hub 28 includes a hub protrusion 28G, a mount portion 28H provided outwardly in the radial direction with respect to the hub protrusion 28G, and a downward projection 28D protruding downwardly from a lower face 28J of the hub protrusion 28G and encircles the bearing unit 12.

A shaft hole 28C is formed in the hub protrusion 28G along the rotation axis R. The upper end of the shaft 26 is press-fitted in the shaft hole 28C. That is, the circumference of the shaft hole 28C is a contact part between the shaft 26 and the hub 28. The shaft 26 is formed of a ferrous material harder than the material of the hub 28, e.g., SUS 420 J2.

The magnetic recording disk 8 is to be fitted to an outer circumference 281 of the hub protrusion 28G, and is to be mounted on a disk mount face 28A that is an upper face of the mount portion 28H. For example, three disk fastening screw holes 34 are provided in an upper face 28B of the hub protrusion 28G around the rotation axis R of the rotor 6 at an angle of 120 degrees. A clamper 36 is attached with pressure to the upper face 28B of the hub protrusion 28G by three disk fastening screws 38 engaged with the three disk fastening screw holes 34, thereby attaching the magnetic recording disk 8 to the disk mount face 28A with pressure.

The thrust member 30 is formed in an annular shape, and has a cross-section that is a reversed L shape. The thrust member 30 is fastened to an inner circumference 28E of the downward projection 28D of the hub 28 by bonding.

The cylindrical magnet 32 is bonded and fastened to a cylindrical inner circumference 28F that is an internal cylindrical face of the hub 28 in a substantially cup shape. The cylindrical magnet 32 is formed of, for example, a rare-earth magnetic material or a ferrite magnetic material. In this embodiment, the cylindrical magnet 32 is formed of a neodymium-based rare-earth magnetic material. Magnetization for driving that is 12 polarities is applied to the cylindrical magnet 32 in the circumferential direction thereof (a tangent line direction of a circle around the rotation axis R and perpendicular thereto). A skin-layer forming process, such as electrodeposition coating or a spray coating, is applied to the surface of the cylindrical magnet 32, and thus a formation of rust, etc., is suppressed. The cylindrical magnet 32 faces the nine salient poles of the laminated core 40 in the radial direction (i.e., a direction perpendicular to the rotation axis R).

(Manufacturing Method)

An explanation will be given of an example case in which the above-explained rotating device 1 is manufactured through the manufacturing method of this embodiment. In the following explanation, the hub 28, the base 4, and other structural components will be collectively referred to as a “work-piece”.

The manufacturing method of this embodiment includes steps for manufacturing a work-piece, assembling the rotating device 1 by assembling the manufactured work-pieces together, and inspecting the appearance, operation, function, etc., of the assembled rotating device 1. The assembling step may be performed through a conventionally well-known technology. The inspecting step may be performed through a conventionally well-known technology.

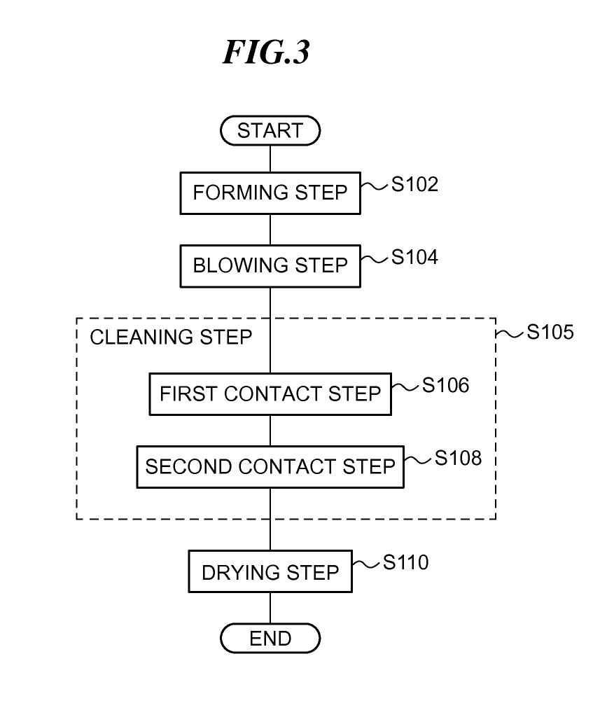

FIG. 3 is an exemplary manufacturing step diagram illustrating a step for manufacturing a work-piece. The step for manufacturing a work-piece includes a forming step S102, a blowing (spraying or blasting) step S104, a cleaning step S105, and a drying step S110. Each step will be explained below in detail with reference to an example case in which a work-piece is basically the hub 28.

In the forming step S102, a ferrous material like SUS 430 F is cut to form the hub 28. At this time, a cutting fluid is used for cooling and lubrication. The cutting fluid contains a large amount of carbon hydride.

Hence, the hub 28 having undergone the cutting has a large amount of carbon hydride and denatured materials thereof, etc., sticking thereto. Moreover, a free-cutting element added to the ferrous material may stick on the cut face as a micro protrusion. That is, foreign materials are sticking to the hub 28.

In the blowing step S104, the hub 28 is blown with grains. The kinetic energy of the grains applies shock to the foreign materials sticking to the hub 28, thereby eliminating the foreign materials.

An explanation will be given of grains blown to the work-piece. When liquid grains are blown, it is difficult to reduce the grain diameter due to the effect of the surface tension of the liquid, and the liquid grains may act like an elastic body due to the surface tension. Accordingly, the kinetic energy at the time of collision is dispersed to the entire liquid grains, and thus there is a possibility that shock to be applied to the foreign materials may become small. Conversely, in the case of solid grains, it is easy to reduce the grain diameter since the effect of the surface tension is little. Moreover, it can be thought that the solid grains do not behave like an elastic body. Accordingly, the kinetic energy at the time of collision is not likely to be dispersed, and large shock is applied to minute foreign materials, thereby effectively eliminating the foreign materials. Hence, it is preferable that the grains to be blown should be solid grains at least until such grains contact a work-piece.

Moreover, in order to suppress a damage to the work-piece, it is preferable that the grains should be a soft material with a lower hardness than that of the work-piece. Furthermore, in order to prevent the grains from being left on the work-piece after cleaning, it is preferable that the grains should have a property that those are vaporized or are soluble with a cleaning fluid in the following cleaning step S105. Still further, it is preferable that the grains should be a material that does not likely produce a rust in a metal in order to suppress a production of rust in cleaning facilities like a cleaning bath.

The kind of such solid grains is not limited to any particular one, but for example, salty grains, such as sodium hydrogen carbonate or calcium carbonate, grains obtained by solidifying a substance that is a gas at a room temperature like dry ice, or grains obtained by solidifying a substance that is a liquid at a room temperature like ice. For example, salty grains are preferable since those are inexpensive and easy to handle. Grains obtained by solidifying a substance that is a gas or a liquid at a room temperature are preferable since those can be easily removed after cleaning. With respect to those solid grains, a solo or multiple kinds of grains may be used. The following explanation will be given of an example case in which the solid grains are sodium hydrogen carbonate used solely in this embodiment.

Next, an explanation will be given of the size of the grains to be blown. When, for example, the grains are blown to a surface having concavities and convexities like streaks formed by cutting, if the size of the grains is equal to or smaller than the pitch of the concavities and convexities (e.g., a pitch of streaks formed by cutting), the foreign materials sticking to the concavity (e.g., streaks formed by cutting) of the convexities and concavities can be effectively eliminated. However, the size of the grains that are materials generally available is often large and non-uniform, and thus when such grains are applied as those are, the foreign-material peeling effects become varied. Hence, prior to the blowing step S104, a pulverizing step for reducing the size of the grains using, for example, a mill or a granulator may be performed. This results in an accomplishment of a stable foreign-material peeling effect.

More specifically, when the pitch of streaks is 30 to 300 μm, it is desirable that the size of the grains should be equal to or smaller than 30 μm. The expression “the size of the grains is equal to or smaller than 30 μm” means a size of the grains that allows equal to or greater than 50% of the grains to pass through a screen having slits at a pitch of 30 μm. When the grains are excessively made thin, it needs an extra work hour to do so, and the mass of the grains becomes too small. Hence, shock to be applied to the foreign materials becomes small, and thus the foreign-material peeling effect becomes unstable. Accordingly, it is desirable that the size of the grains should be equal to or greater than 5 μm. Moreover, when stocked, the grains may stick together, resulting in an increase in the grain size. Hence, it is desirable to successively execute the blowing step S104 from the pulverizing step.

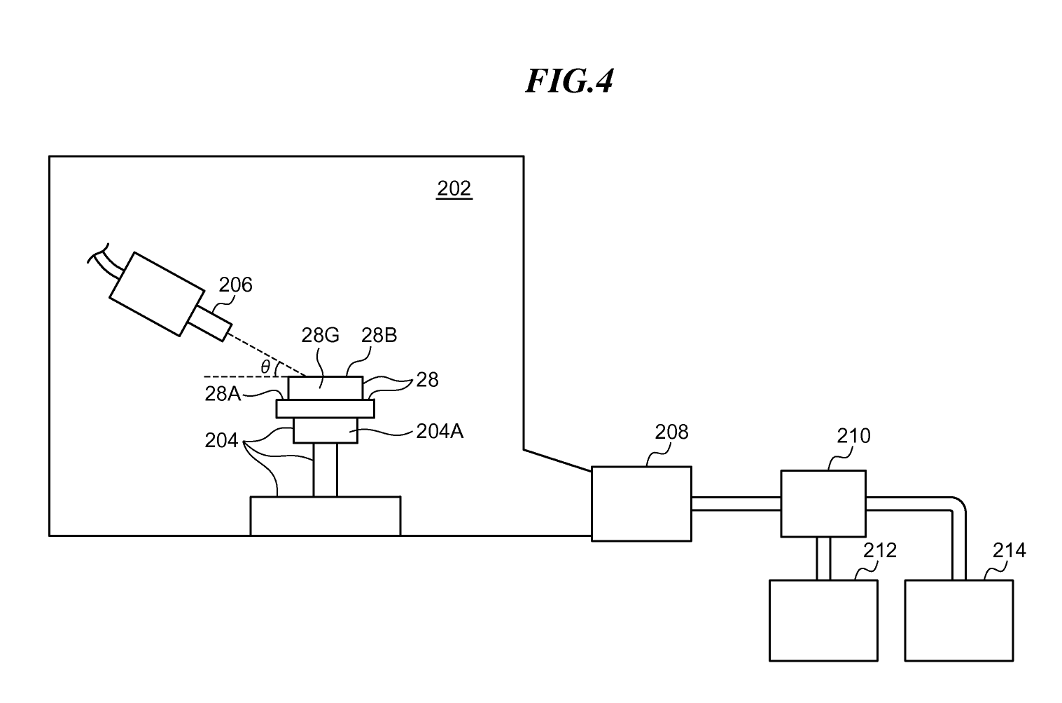

FIG. 4 is an exemplary diagram illustrating the blowing step S104. In this example, solid grains of sodium hydrogen carbonate are blown to the hub 28. The blowing step S104 is performed in a work space 202 closed so as to prevent the grains of sodium hydrogen carbonate from splashed to the peripheral area.

In the blowing step S104, first, the hub 28 together with a support table 204 is entered in the work space 202 through an inlet (unillustrated). The hub 28 is supported with the upper face 28B of the hub protrusion 28G being directed upwardly. Next, a plate 204A of the support table 204 is rotated to turn the hub 28 around the rotation axis R. In this condition, the grains of sodium hydrogen carbonate are blown together with compressed air through a nozzle 206 toward the upper face 28B of the hub 28 and the disk mount face 28A. Accordingly, carbon hydride (including denatured materials, etc., thereof), micro protrusions of the free-cutting element, and other foreign materials sticking to mainly the upper face 28B and disk mount face 28A of the hub 28 can be blown off. Alternatively, even if those foreign materials are not blown off, the sticking force to the hub 28 can be weakened. According to the tests performed by the inventors of the present invention, an elimination effect of foreign materials, etc., was confirmed when the rotation speed of the hub 28 was within a range from 0.5 to 50 Hz, the pressure of the compressed air was within a range from 0.2 to 0.5 Mpa, the flow rate was within a range from 80 to 200 L/min, and an angle 8 between the upper face 28B and the disk mount face 28A, and, the blowing direction was a keen angle that was within a range from 15 to 60 degrees. The rotation speed of the hub 28, the angle 8 for blowing the compressed air to the hub 28, the pressure of the compressed air, and the flow rate may be changed to obtain a desired cleaning effect. Note that other example gases to be blown together with the grains from the nozzle 206 are nitrogen and CO₂.

Moreover, while the grains of sodium hydrogen carbonate are blown, a suction device 208 provided at the opposite side to the nozzle 206 with respect to the hub 28 suctions the peripheral atmosphere of the hub 28. Accordingly, the peeled foreign materials are prevented from flying in the work space 202, and prevented from sticking again to the hub 28. The suctioned foreign materials and grains of sodium hydrogen carbonate are separated through a filter 210, and collected in a foreign-material collector tank 212 and a sodium hydrogen carbonate collector tank (grain collector tank) 214, respectively.

Next, an explanation will be given of the cleaning step S105. In the cleaning step S105, the hub 28 is dipped in the cleaning fluid in the cleaning bath to rinse the hub 28. In order to suppress a rust and an occurrence of tarnishing, it is desirable to carry out the cleaning step S105 as soon as possible after the blowing step S104.

The inventors of the present invention keenly studied about how to effectively eliminate the micro protrusions of the free-cutting element and denatured materials, etc., thereof left on the work-piece in the cleaning fluid in the cleaning bath. Subsequently, the inventors of the present invention obtained the following knowledge with respect to a factor that makes the cleaning effect varied or reduced when ultrasound is applied to the cleaning fluid in the cleaning bath where the work-piece is dipped from an ultrasound generator.

First, an explanation will be given of a power density of ultrasound.

The inventors of the present invention found that when an ultrasound output is constant, if the volume of the cleaning fluid in the cleaning bath is increased, the cleaning effect is made varied or reduced, or if the volume of the cleaning fluid is reduced, the cleaning effect is improved. Moreover, the inventors of the present invention also found that when the volume of the cleaning fluid in the cleaning bath is constant, if an ultrasound output is reduced, the cleaning effect is made varied or reduced, or if the ultrasound output is increased, the cleaning effect is improved. That is, when an ultrasound power density P/V (W/L) that is a ratio between an ultrasound output P (Watt) and the volume V (Liter) of the cleaning fluid in the cleaning bath is increased, the cleaning effect is improved. Moreover, it was confirmed through the inventors' keen study that when the ultrasound power density P/V (W/L) is equal to or greater than 10 (W/L), the variance of the cleaning effect is remarkably reduced, and the cleaning effect is improved.

When the ultrasound output P (W) is simply increased, unpleasant noises become also loud, and thus a work environment is deteriorated. Moreover, when a large power is applied to the ultrasound generator to increase the ultrasound output P (W), the lifetime of the ultrasound generator is reduced, resulting in a tendency that the reliability is decreased. Conversely, when the volume V (L) of the cleaning fluid in the cleaning bath is reduced to increase the ultrasound power density P/V (W/L), the deterioration of the work environment and the reduction of the reliability of the ultrasound generator are relatively suppressed. More specifically, the volume of the cleaning fluid in the cleaning bath can be controlled using a fluid level adjuster that adjusts the position of the fluid level of the cleaning fluid in the cleaning bath within a desired range to set the ultrasound power density of the cleaning fluid to be a desired level that is equal to or greater than 10 (W/L). The fluid level adjuster includes a unit that supplies a predetermined amount of cleaning fluid to the cleaning bath at a predetermined timing and a unit for discharging the cleaning fluid when the fluid level of the cleaning fluid in the cleaning bath exceeds a set height.

Next, an explanation will be given of a frequency of the ultrasound.

First of all, the inventors of the present invention studied about a method of increasing the ultrasound output using ultrasound with a frequency that was one to twice as much as the maximum audible frequency that was like 20 to 40 kHz. When, however, ultrasound in such a frequency range is used, unpleasant noises are also produced, and thus the work environment is deteriorated. Moreover, when the ultrasound output is increased in a frequency range like 20 to 40 kHz, the possibility that the surface of the work-piece subjected to the cleaning is made rough becomes high due to erosion near the ultrasound generator, and the possibility that the lifetime of the ultrasound generator is reduced becomes also high. When the ultrasound output is increased using ultrasound within a range from 80 to 200 kHz that are a frequency four to ten times as much as the maximum audible frequency, an advantage that unpleasant noises are suppressed and the deterioration of the work environment is suppressed is confirmed.

Next, an explanation will be given of an effective cleaning range by ultrasound.

In this example, the inventors of the present invention studied about a work angle between a straight line running from the ultrasound generator to the work-piece with the ultrasound generator in the cleaning fluid being disposed so as to have the output direction directed vertically and upwardly, and, the output direction. It was confirmed that when the work angle is large, the cleaning effect is reduced or is made varied. That is, when the work-piece in the cleaning fluid in the cleaning bath moves horizontally, the region where the work-piece is effectively cleaned is limited to a nearby area right above the ultrasound generator, and the cleaning effect is reduced in other regions. When the number of ultrasound generators is increased or the number of installed cleaning bath is increased to make the region where the work-piece is effectively cleaned widespread, the facilities become expensive.

Next, the fluid level of the cleaning fluid was changed using the fluid level adjuster, and a change in the cleaning effect was observed. As a result, it was confirmed that when the vertical distance between the ultrasound generator and the fluid level is substantially integral multiple of the half wavelength of ultrasound, the cleaning effect remarkably improves. This is because the phase of vibration by ultrasound going up in the cleaning fluid and that of vibration by ultrasound reflected by the fluid level and going down may be resonated, the respective ultrasounds may be enhanced with each other, and thus attenuation of vibration may be suppressed. When the vertical distance is too short, the body subjected to cleaning may protrude from the fluid level. Conversely, when the vertical distance is too long, the ultrasound power density of the cleaning fluid may decrease. It is confirmed that when the vertical distance is at least substantially integral multiple of the half wavelength of the ultrasound within a range from four to ten times, there is no practical issue that the cleaning target may protrude from the fluid level, and the ultrasound power density of the cleaning fluid can be maintained within a desired range. It was also confirmed that when the vertical distance between the ultrasound generator and the fluid level is substantially integral multiple of the half wavelength of ultrasound, the effective cleaning range can be made widespread, and attenuation of ultrasound can be suppressed. Accordingly, when the work-piece in the cleaning fluid in the cleaning bath moves horizontally, the micro protrusions of the free-cutting element and denatured materials, etc., sticking to the work-piece can be effectively eliminated in regions other than the nearby area right above the ultrasound generator within a predetermined manufacturing takt time.

Next, an explanation will be given of a bubble nucleus (cavitation nucleus) increaser.

It was observed through the study by the inventors of the present invention that a work hour necessary for eliminating the micro protrusions of the free-cutting element and denatured materials, etc., sticking to the work-piece varies depending on a day and is non-uniform. This is because, even if under the same cleaning condition, when the contained amount of cavitation nuclei in the cleaning fluid is little, the occurrence of cavitation by ultrasound may become little, and thus the cleaning effect may be reduced. The cavitation nuclei are minute gas that are equal to or smaller than 100 μm in the cleaning fluid, and have a property of causing cavitation by expansion and shrinkage when affected by ultrasound. Hence, when the amount of cavitation nuclei is little, the efficiency of the occurrence of cavitation is reduced. Accordingly, a step for increasing the cavitation nuclei in the cleaning fluid can be preferably added. For example, a step for pumping the cleaning fluid from the cleaning bath to fill the pumped fluid in the cleaning bath through a cavitation nucleus increaser may be performed. For example, the cavitation nucleus increaser applies ultrasound vibration to the cleaning fluid, and increases the amount of cavitation nuclei in the cleaning fluid which will be the core of cavitation.

More specifically, the cleaning fluid in the cleaning bath is pumped up, filtrated through a filter to remove foreign materials, and ultrasound is applied to the filtrated fluid in a bubble adjusting tank to cause a resonance, thereby increasing the amount of cavitation nuclei. Subsequently, the fluid is returned to the cleaning bath. A bubble adjusting tank may be placed at the input side of the pump, but in this case, there is a possibility that the cavitation nuclei may decrease through the process of causing the cleaning fluid to pass through the pump. Hence, it is preferable that the bubble adjusting tank should be placed at an output side of the pump. The use of the cavitation nucleus increaser suppresses a reduction of the amount of cavitation nuclei in the cleaning fluid, and a variance of the cleaning effect.

The specific detail of the cleaning step S105 in this embodiment will be explained below.

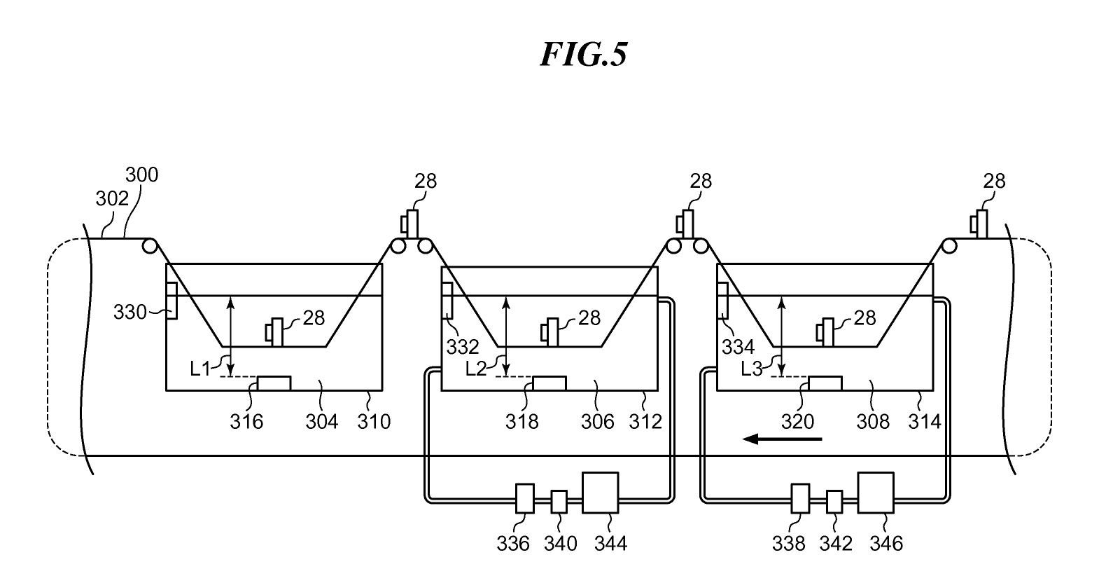

The cleaning step S105 includes a first contact step S106 and a second contact step S108. FIG. 5 is an exemplary diagram illustrating the first contact step S106. In the first contact step S106, the hub 28 is rinsed as a pre-cleaning of the second contact step S108 that is an actual cleaning. More specifically, the hub 28 is carried by a carrier device 300, and is cleaned by ultrasound while moving in respective pre-cleaning fluids that are a first pre-cleaning fluid 304, a second pre-cleaning fluid 306, and a third pre-cleaning fluid 308, in this order.

The carrier device 300 is a chain conveyer to which the support table that supports the hub 28 is attached. In this example, the carrier device 300 moves a chain 302 in the clockwise direction, and carries the hub 28 together with the support table (unillustrated).

The first pre-cleaning fluid 304, the second pre-cleaning fluid 306, and the third pre-cleaning fluid 308 are reserved in respective first pre-cleaning bath 310, second pre-cleaning bath 312, and third pre-cleaning bath 314. The grains, i.e., sodium hydrogen carbonate blown to the hub 28 in the blowing step S104 has a property that is soluble with the first, second and third pre-cleaning fluids 304, 306, and 308. The term “property that is soluble” means, for example, that sodium hydrogen carbonate of equal to or greater than 8 g can be dissolved in the cleaning fluid of 100 g at a temperature of 25° C. The first pre-cleaning fluid 304 is an aqueous solution mainly containing a surfactant agent as a solute, and the temperature thereof is set within a range from 60 to 70° C. The second and third pre-cleaning fluids 306 and 308 are each a liquid substantially presumable as pure water, and the temperature thereof is set to be around a normal temperature. More specifically, such a temperature is set within a range from 25 to 35° C. for example. The second pre-cleaning fluid 306 has the amount of cavitation nuclei increased by a first pump 336, a first filter 340 and a first cavitation nucleus increaser 344. More specifically, the first pump 336 pumps out the second pre-cleaning fluid 306 from the second pre-cleaning bath 312, the pumped fluid is filtrated by the first filter 340 to eliminate foreign materials, and is fed to the first cavitation nucleus increaser 344. Next, the first cavitation nucleus increaser 344 increases the amount of cavitation nuclei, and the second pre-cleaning fluid 306 is returned to the second pre-cleaning bath 312. The third pre-cleaning fluid 308 also has the amount of cavitation nuclei increased by a second pump 338, a second filter 342, and a second cavitation nucleus increaser 346. The second pump 338, the second filter 342, and the second cavitation nucleus increaser 346 correspond to the first pump 336, the first filter 340, and the first cavitation nucleus increaser 344.

In this embodiment, the carrying speed, etc., of the carrier device 300 is set in such a way that a necessary time for the hub 28 to move through each pre-cleaning fluid is substantially 100 seconds, and ultrasounds of 20 to 30 kHz are applied to the respective cleaning fluids from first, second and third ultrasound generators 316, 318 and 320. Moreover, in order to enhance the cleaning effect, ultrasound output and the volume of the cleaning fluid are adjusted so as to obtain ultrasound power density that is equal to or greater than 10 W/L. In order to adjust the volumes of the first, second and third pre-cleaning fluids 304, 306, and 308, a first fluid level adjuster 330, a second fluid level adjuster 332, and a third fluid level adjuster 334 are applied.

Moreover, using the first fluid level adjuster 330, a distance L1 between the fluid level of the first pre-cleaning fluid 304 and the first ultrasound generator 316 can be adjusted so as to be the integral multiple (within a range from four to ten times) of the half wavelength of ultrasound applied to the first pre-cleaning fluid 304 from the first ultrasound generator 316. A distance L2 between the fluid level of the second pre-cleaning fluid 306 and the second ultrasound generator 318, and a distance L3 between the fluid level of the third pre-cleaning fluid 308 and the third ultrasound generator 320 may be also adjusted in the same manner by the second fluid level adjuster 332 and the third fluid level adjuster 334.

An explanation will now be given of the cleaning bath.

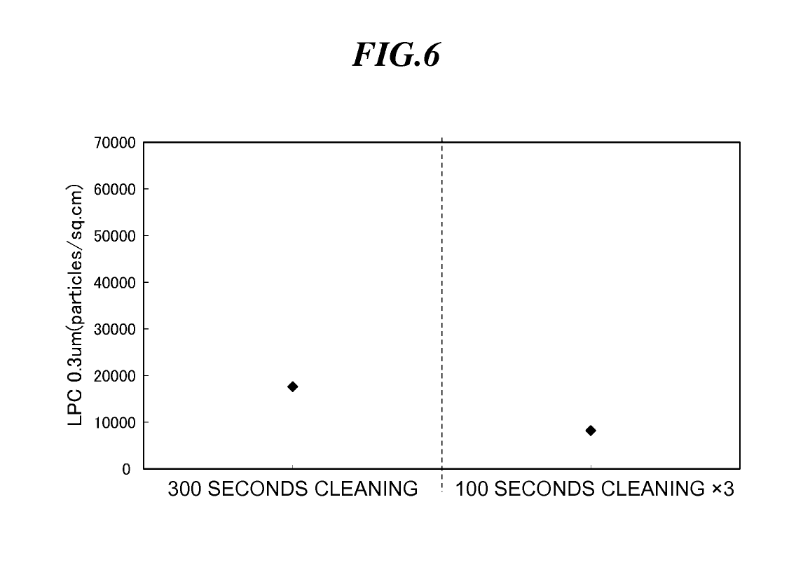

FIG. 6 illustrates a cleanness when the hub 28 was cleaned by a bath alone, and a cleanness when the hub 28 was cleaned by three bathes individually.

More specifically, FIG. 6 illustrates the number of foreign materials (hereinafter, referred to as an LPC) with a grain diameter of equal to or greater than 0.3 μm and sticking to the surface of the hub 28 per 1 cm². The left part of FIG. 6 illustrates a cleanness when the hub 28 was dipped in a cleaning bath and was subjected to ultrasound cleaning for substantially 300 seconds, and the right part of FIG. 6 illustrates a cleanness when the hub 28 was dipped in three bathes individually and was subjected to ultrasound cleaning for substantially 100 seconds. When both cleanness are compared, the value of LPC is small in the case of the three bathes (multiple bathes). That is, it becomes clear that the cleaning effect is high. Hence, according to this embodiment, the cleaning bathes installed are three bathes that are the first pre-cleaning bath 310, the second pre-cleaning bath 312, and the third pre-cleaning bath 314.

When the hub 28 is cleaned by one bath alone, it is advantageous for the smaller installation space of the facilities and the smaller installation costs, and the number of cleaning bathes can be selected in accordance with the desired cleanness.

An explanation will be also given of a frequency of ultrasound applied to the first, second and third pre-cleaning fluids 304, 306, and 308.

Small foreign materials may be sticking behind large foreign materials sticking to the hub 28. In this case, in order to eliminate effectively such small foreign materials, it is preferable to eliminate the large foreign materials at first. Hence, ultrasound with a relatively low frequency is applied in the first contact step S106. Ultrasound with a relatively high frequency is applied in the second contact step S108 to be discussed later.

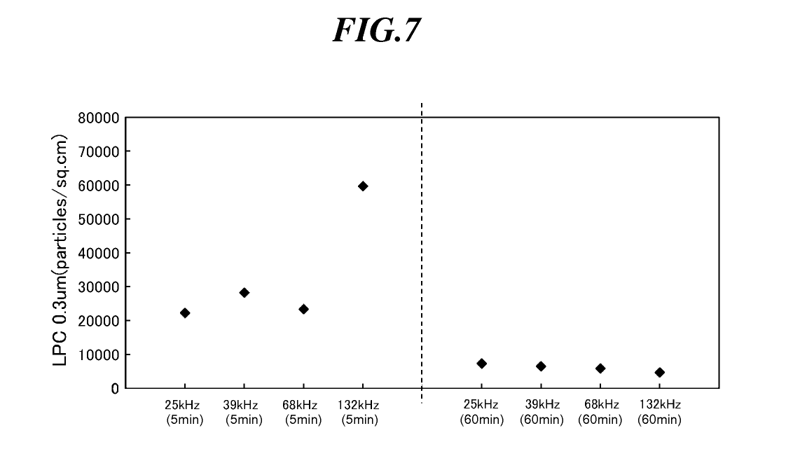

Next, a test for studying a relationship between the frequency of ultrasound and a cleaning time was performed, and the following result was obtained. FIG. 7 illustrates a distribution of cleanness for cleaning of the hub 28 in various conditions. The left part of FIG. 7 illustrates a distribution of cleanness when the hub 28 was cleaned by five minutes, and the right part of FIG. 7 illustrates a distribution of cleanness when the hub 28 was cleaned by 60 minutes. Based on the test result, it becomes clear that when the cleaning time is 60 minutes, i.e., when the cleaning time is relatively long, the similar cleaning effect can be obtained regardless of the frequency. Conversely, it becomes clear that when the cleaning time is five minutes, i.e., when the cleaning time is relatively short, the lower the frequency is, the higher the cleaning effect becomes. When, in particular, the frequency is 25 kHz, the similar cleaning effect to that of the case when the cleaning time is 60 minutes can be obtained. When the frequency of ultrasound is set to be lower than 20 kHz, the lifetime of the ultrasound generator itself may become short, negatively affecting the manufacturing facilities.

Based on the above-explained result, the frequency of ultrasound in the first contact step S106 is set to be 20 to 30 kHz in this embodiment.

When the frequency of ultrasound is set to be higher than 30 kHz, it is advantageous since unpleasant noises can be suppressed. Hence, the frequency can be selected in accordance with the desired condition.

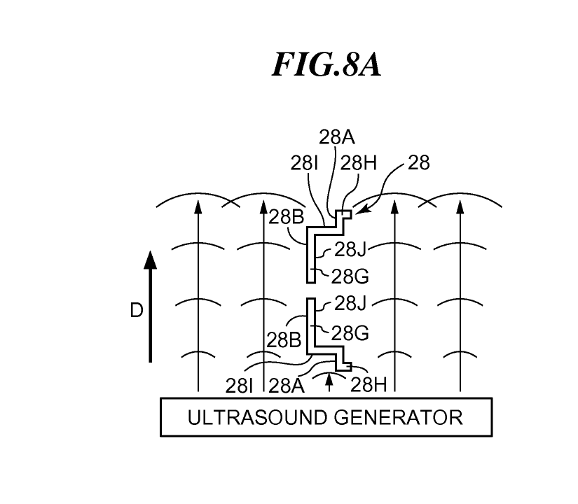

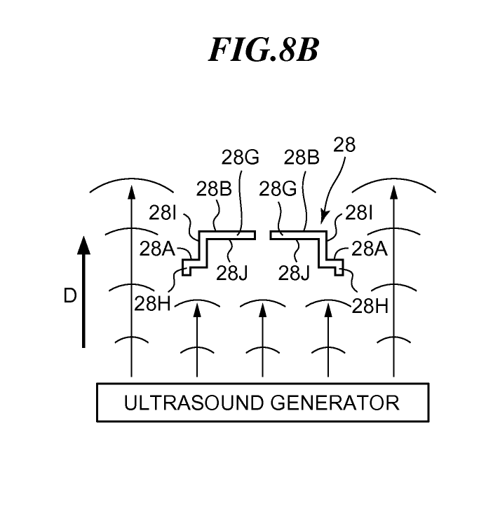

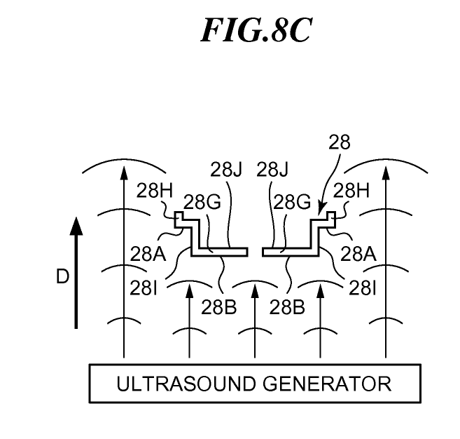

Next, an explanation will be given of a posture of the hub 28 during ultrasound cleaning. FIGS. 8A to 8C are exemplary diagrams illustrating how the hub 28 is irradiated with ultrasound through the cleaning fluid. FIG. 8A illustrates a posture of the hub 28 according to this embodiment, while FIGS. 8B and 8C illustrate postures of the hub 28 in comparative examples. In FIG. 8A, the hub 28 is supported in such a way that the upper face 28B of the hub protrusion 28G and the disk mount face 28A are substantially parallel with a direction D in which ultrasound propagates. Conversely, in FIG. 8B, the hub 28 is supported in such a way that the upper face 28B of the hub protrusion 28G and the disk mount face 28A are substantially orthogonal to the ultrasound propagating direction D, and the upper face 28B and the disk mount face 28A are directed opposite to the ultrasound generator. In FIG. 8C, the hub 28 is supported in such a way that the upper face 28B of the hub protrusion 28G and the disk mount face 28A are substantially orthogonal to the ultrasound propagating direction D, and the upper face 28B and the disk mount face 28A are directed toward the ultrasound generator.

Since ultrasound is a relatively high frequency, a phenomenon of going around behind an obstacle, i.e., a diffraction is not likely to occur. Hence, in FIG. 8B, the hub 28 itself becomes an obstacle, and a relatively large area of the upper face 28B of the hub protrusion 28G is not likely to be irradiated with ultrasound. Likewise, in FIG. 8C, the hub 28 itself becomes an obstacle, and a relatively large area of the lower face 28J of the hub protrusion 28G is not likely to be irradiated with ultrasound. Conversely, according to a posture in FIG. 8A that is the posture of the hub 28 according to this embodiment, both upper face 28B and lower face 28J of the hub 28 can be irradiated with ultrasound. Moreover, a portion of the hub 28 shaded by the hub 28 itself is merely a part of the outer circumference 281 that is narrow, which has a short distance from the shaded portion, and thus foreign materials sticking to the hub 28 can be effectively eliminated as a whole.

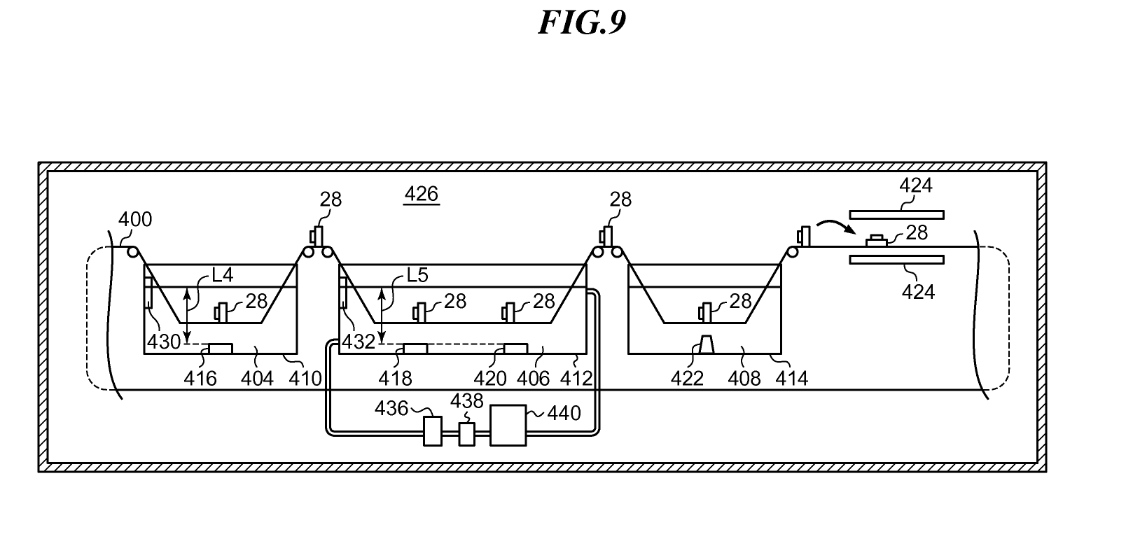

FIG. 9 is an exemplary diagram illustrating the second contact step S108 and the drying step S110. A carrier device 400 is utilized for those steps. The carrier device 400 employs the same structure as that of the carrier device 300.

In the second contact step S108, the hub 28 through the blowing step S104 and the first contact step S106 is actually cleaned in a clean room 426. The clean room 426 is filled with clean air, and has a higher cleanness than the atmosphere where the first contact step S106 is performed. The cleanness of the clean room 426 can be set to, for example, substantially class 1000.

The hub 28 is carried by the carrier device 400, and is cleaned while moving through respective cleaning fluids that are a first actual cleaning fluid 404, a second actual cleaning fluid 406, and a third actual cleaning fluid 408, in this order. The hub 28 is subjected to ultrasound cleaning in the first and second actual cleaning fluids 404 and 406, and is subjected to a mainstream cleaning in the third actual cleaning fluid 408.

The first, second, and third actual cleaning fluids 404, 406, and 408 are reserved in a first actual cleaning bath 410, a second actual cleaning bath 412, and a third actual cleaning bath 414, respectively. Sodium hydrogen carbonate may have a property that is soluble with the first, second and third actual cleaning fluids 404, 406, and 408. The first actual cleaning fluid 404 is an aqueous solution mainly containing a surfactant agent as a solute, and the temperature thereof is set to be within a range from 60 to 70° C. The second actual cleaning fluid 406 is a liquid that can be substantially presumed as pure water, and the temperature thereof is set to be substantially a normal temperature. More specifically, such a temperature range is set to be from 25 to 35° C. The second actual cleaning fluid 406 has the amount of cavitation nuclei increased by a third pump 436, a third filter 438, and a third cavitation nucleus increaser 440. The third pump 436, the third filter 438, and the third cavitation nucleus increaser 440 correspond to the first pump 336, the first filter 340, and the first cavitation nucleus increaser 344, respectively. The third actual cleaning fluid 408 is a liquid that can be substantially presumed as pure water, and the temperature range thereof is set to be from 40 to 50° C. When the third actual cleaning fluid 408 is set to have a higher temperature than a normal temperature, the time of the following drying step S110 can be reduced.

According to this embodiment, the carrying speed, etc., of the carrier device 400 is set in such a way that the necessary time for the hub 28 to move through each cleaning fluid is 5 to 10 minutes, and a fourth ultrasound generator 416 applies ultrasound of 40 kHz to the first actual cleaning fluid 404. A fifth ultrasound generator 418 and a sixth ultrasound generator 420 apply ultrasounds of 40 kHz and 68 kHz, respectively, to the second actual cleaning fluid 406. Since the fifth ultrasound generator 418 and the sixth ultrasound generator 420 apply ultrasounds of different frequencies, vibration that is a beat of those ultrasounds is generated. As a result, the frequency spectrum of ultrasound can be made widespread, reducing the non-uniformity of cleaning, and improving the elimination performance of the foreign materials. Like the first contact step S106, the ultrasound output and the volume of the cleaning fluid are adjusted so as to accomplish the power density that is equal to or greater than 10 W/L. To adjust the respective volumes of the first actual cleaning fluid 404 and the second actual cleaning fluid 406, a fourth fluid level adjuster 430 and a fifth fluid level adjuster 432 are applied. The fourth fluid level adjuster 430 may adjust a distance L4 between the fluid level of the first actual cleaning fluid 404 and the fourth ultrasound generator 416 so as to be integral multiple of the half wavelength of ultrasound applied to the first actual cleaning fluid 404 from the fourth ultrasound generator 416 within a range from 4 to 10 times. The same is true of a distance L5 between the fluid level of the second actual cleaning fluid 406 and the fifth ultrasound generator 418 and the sixth ultrasound generator 420 which can be adjusted by the fifth fluid level adjuster 432.

In the third actual cleaning fluid 408, the cleaning fluid is sprayed from a spray nozzle 422 to generate a mainstream in the third actual cleaning fluid 408. This mainstream peels the foreign materials not eliminated yet and the foreign materials sticking again to the hub 28 in the other cleaning fluids.

In a drying step S110, first, the posture of the supported hub 28 is changed in such a way that the disk mount face 28A is directed upwardly. Next, the hub 28 moving in a drying furnace 424 is blown by hot air. The hot air is blown from both sides that are the disk-mount-face-28A side and the opposite side thereof. The temperature of the hot air and the blowing time can be set based on a test.

The hub 28 after the drying step S110 is utilized in an assembling step.

Other work-pieces than the hub 28 are also manufactured through the similar forming, blowing, cleaning, and drying steps. When the base 4 is manufactured, the base 4 is formed by die-cast molding on an aluminum alloy. When the base 4 is manufactured, the blowing step S104 may be omitted. Moreover, a step for cleaning the six screw holes 22 of the base 4 may be performed prior to the second contact step S108 that is an actual cleaning. The step for cleaning the screw holes 22 may be a conventional cleaning technology. The ultrasound power density applied to the cleaning fluid in the first contact step S106 and the second contact step S108 may be adjusted in accordance with a material.

According to the manufacturing method of this embodiment, the structural component of the rotating device 1 is blown by the grains. This reduces the foreign materials sticking to the structural component. The grains have a property that is soluble with the cleaning fluid to be contacted with the structural component later. Hence, the structural component blown by such grains are caused to contact with the cleaning fluid, thereby eliminating the grains sticking to the structural component, and reducing the foreign materials sticking to the structural component. Those processes are performed prior to the actual cleaning, and thus a desired cleanness can be obtained with a relatively short actual cleaning time. That is, when a higher cleanness than conventional cases is required, the increase in the manufacturing time of the rotating device can be suppressed, but the foreign materials sticking to the structural component of the rotating device can be surely reduced.

The execution of the blowing step S104 and the first contact step S106 enables a reduction of the necessary time for the second contact step S108, and thus the total manufacturing time by the manufacturing method of this embodiment can be reduced in comparison with the conventional manufacturing method.

The explanation was given of the method for manufacturing a rotating device according to an embodiment. This embodiment is merely an example, and various modifications can be made to the combination of respective structural elements. It should be understood that such modifications are also within the scope and spirit of the present invention.

The explanation was given of a case in which the rotating device 1 that is a hard disk drive is manufactured, but the manufacturing target is not limited to hard disk drives. For example, the technical thought of the embodiment is applicable to any manufacturing method of a rotating device that needs to clean a structural component in order to eliminate foreign materials in a manufacturing process.

In the above-explained embodiment, the explanation was given of a case in which the hub 28 is formed by cutting and machining, but the present invention is not limited to this case, and for example, the hub 28 may be formed by plastic forming like pressing. In this case, carbon hydride, etc., utilized for such a work may be transferred and stick to the hub 28 after the formation as foreign materials. Hence, such sticking foreign materials can be eliminated from the hub 28 through the similar cleaning of the above-explained embodiment.

In the above-explained embodiment, the explanation was given of a case in which the base 4 is formed by die-cast molding of an aluminum alloy, but the present invention is not limited to this case. For example, the base 4 may be formed by pressing of a sheet metal, such as an aluminum plate or a steel plate. In this case, an embossed portion may be formed in such a way that a pushed-up convexity is formed in one face of the base 4 and a concavity corresponding to such a convexity is formed in another face of the base 4. When an embossed portion is formed at a predetermined location, a deformation of the base 4 can be suppressed. In this case, a surface process, such as plating or resin coating, may be applied to the base 4. For example, a nickel plating layer and an epoxy resin surface layer may be formed after a steel sheet is shaped by pressing.

The base 4 may include a sheet-metal processed part formed by pressing a sheet metal, such as an aluminum plate or a steel plate, and a die-cast part formed by die-cast molding of aluminum in combination with the sheet-metal processed part. For example, the bottom portion 4A may include the sheet-metal processed part, while the outer circumferential wall 4B may include the die-cast part. Such a structure suppresses a reduction of the rigidity of the screw holes 22. An example method for manufacturing such a base 4 is to form the die-cast part by aluminum die-casting with the sheet-metal processed part already shaped being in a mold for aluminum die-casting. According to such a manufacturing method, a joining work for the sheet-metal processed part and the die-cast part can be reduced, and the dimensional precision with respect to the sheet-metal processed part and the die-cast part each other can be improved. Alternatively, it becomes possible to reduce or eliminate a member for joining the sheet-metal processed part with the die-cast part. As a result, it becomes easy to make the base 4 thin.

In the case of the base 4 formed as explained above, carbon hydride, etc., utilized for such a work may be transferred and stick to the formed base 4 as foreign materials. Hence, such sticking foreign materials can be eliminated from the base 4 by the similar cleaning of the above-explained embodiment.

In the above-explained embodiment, the explanation was given of a case in which any one of the cleaning fluids is an aqueous solution mainly containing a surfactant agent as a solute, but the present invention is not limited to this case. For example, an aqueous solution that contains at least one of ester and ether, and, a surfactant agent at a mass ratio of 1:1 to 1:4 that is a ratio between the total of ester or ether and the surfactant agent. It is confirmed that fatty acid ester or fatty acid sticking to a structural component can be effectively eliminated. In this case, it is also confirmed that the cleaning effect is enhanced, respectively, when (1) the molecular mass of ester and ether is 118 to 188, (2) the temperature of the aqueous solution is equal to or lower than 70° C., (3) ester is fatty acid diester, and (4) the aqueous solution further contains organic acid.

In the above-explained embodiment, the explanation was given of a case in which the hub 28 was dipped in the cleaning fluid to perform ultrasound cleaning, but the present invention is not limited to this case. For example, shower cleaning or other cleaning schemes are applicable.

In the above-explained embodiment, the explanation was given of a case in which both first contact step S106 and second contact step S108 employ respective three cleaning bathes, but the number of cleaning bathes is not limited to this case. For example, the number of bathes may be one, two or equal to or greater than four.

In the above-explained embodiment, the explanation was given of a case in which after the hub 28 is formed by cutting and machining, the hub 28 is cleaned in solo, but the present invention is not limited to this case. For example, a step for attaching the cylindrical magnet 32 to the hub 28 may be performed between the first contact step S106 of the hub 28 and the second contact step S108 thereof. When the cylindrical magnet 32 is bonded and fastened to the hub 28 after the hub 28 is cleaned and dried, a bond or grease may stick to the hub 28 and the cylindrical magnet 32 from the hand of a worker or the manufacturing facilities at the time of bonding and fastening work. In contrast, according to the manufacturing method of this modification, the hub 28 is cleaned after the cylindrical magnet 32 is attached thereto, and thus the amount of sticking bond and grease at the time of bonding and fastening work can be reduced by cleaning.

The same is true of the base 4 and the laminated core 40. That is, a step for attaching the laminated core 40 to the base 4 may be performed between the first contact step S106 of the base 4 and the second contact step S108 thereof. In this case, in the second contact step, the base 4 attached with the laminated core 40 is dipped in the cleaning fluid and is subjected to ultrasound cleaning.

The solid grains to be blown and applicable in the blowing step S104 can be any of never-used grains, used grains collected in the grain collector tank 214, and a mixture of never-used grains and collected and used grains. In other words, the collected grains are reusable in the blowing step S104. As an example, it is confirmed that even if used grains at a ratio of 5 mass % to 50 mass % are mixed and used with never-used grains, a desired cleaning effect can be obtained through a test. It is preferable from the standpoint of resource protection.

What is claimed is:

1. A method for manufacturing a rotating device, the rotating device comprising a hub on which a recording disk is to be mounted, and a base that supports the hub in a freely rotatable manner, when at least one of the base and the hub is referred to as a work-piece, the method comprising:
a forming step for forming a work-piece;
a blowing step for blowing the formed work-piece with solid grains;
a cleaning step for cleaning the work-piece blown by the grains using a cleaning fluid; and
an assembling step for assembling the rotating device using the cleaned work-piece,
wherein the grains have a property of vaporizing in the cleaning step or being soluble with the cleaning fluid therein.

2. The rotating device manufacturing method according to claim 1, wherein the blowing step includes a pulverizing step for pulverizing the grains into a size of equal to or smaller than 30 μm, and the pulverized grains are blown to the work-piece.

3. The rotating device manufacturing method according to claim 1, wherein:
the forming step includes a cutting step for forming a cut face on the work-piece; and
a size of the grains blown to the work-piece in the blowing step is equal to or smaller than a cutting pitch formed on the cut face.

4. The rotating device manufacturing method according to claim 1, wherein the grains blown to the work-piece in the blowing step is formed of a softer material than a material of the work-piece.

5. The rotating device manufacturing method according to claim 1, wherein:
the cleaning step comprises:
a first contact step for causing the work-piece blown by the grains to be in contact with a first cleaning fluid; and
a second contact step for allowing the work-piece caused to be in contact with the first cleaning fluid to be further in contact with a second cleaning fluid; and
the second contact step is performed in a clean room with a higher cleanness than an atmosphere of the first contact step.

6. The rotating device manufacturing method according to claim 1, wherein:
the cleaning step comprises an ultrasound applying step for applying ultrasound to the work-piece from an ultrasound generator with the work-piece being dipped in the cleaning fluid in a cleaning bath; and
the ultrasound applying step adjusts, using a fluid level adjuster that adjusts a position of a fluid level of the cleaning fluid within a predetermined range, a vertical distance between the ultrasound generator and the fluid level so as to accomplish an ultrasound power density in the cleaning fluid that is equal to or greater than 10 (W/L) where the ultrasound power density is a ratio between an ultrasound power (Watt) and a volume (Liter) of the cleaning fluid.

7. The rotating device manufacturing method according to claim 6, wherein the ultrasound applying step adjusts the vertical distance between the ultrasound generator and the fluid level to be n times (where n is an integer within a range from four to ten) as much as a half wavelength of ultrasound.

8. The rotating device manufacturing method according to claim 6, wherein the ultrasound generator outputs ultrasound with a frequency within a range from 80 to 200 kHz.

9. The rotating device manufacturing method according to claim 6, wherein when the work-piece is the hub, in the cleaning step, the hub is supported in such a way that a disk mount face of the hub is substantially parallel with a direction in which ultrasound propagates.

10. The rotating device manufacturing method according to claim 6, wherein:
the cleaning step comprises a step for pumping out the cleaning fluid from the cleaning bath, filtering the pumped-out fluid, and filling the filtrated fluid in the cleaning bath through a cavitation nucleus increaser; and
the cavitation nucleus increaser applies ultrasound to the cleaning fluid to cause a resonance, thereby increasing, in the cleaning fluid, an amount of cavitation nuclei having a predetermined property.

11. The rotating device manufacturing method according to claim 1, wherein the cleaning step cleans the work-piece using the cleaning fluid that is an aqueous solution containing at least either one of ester and ether, and, a surfactant agent at a mass ratio between a total of ester and ether and the surfactant agent within a range from 1:1 to 1:4.

12. The rotating device manufacturing method according to claim 1, further comprising a collecting step for collecting the blown grains to the work-piece.

13. A method for manufacturing a rotating device, the rotating device comprising a hub on which a recording disk is to be mounted, and a base that supports the hub in a freely rotatable manner, when at least one of the base and the hub is referred to as a work-piece, the method comprising:
a forming step for forming a work-piece;
a blowing step for blowing the formed work-piece with solid grains that contain sodium hydrogen carbonate;
a cleaning step for cleaning the work-piece blown by the grains using a cleaning fluid; and
an assembling step for assembling the rotating device using the cleaned work-piece.

14. The rotating device manufacturing method according to claim 13, wherein the blowing step includes a pulverizing step for pulverizing the grains into a size of equal to or smaller than 30 μm, and the pulverized grains are blown to the work-piece.

15. The rotating device manufacturing method according to claim 13, wherein:
the forming step includes a cutting step for forming a cut face on the work-piece; and
a size of the grains blown to the work-piece in the blowing step is equal to or smaller than a cutting pitch formed on the cut face.

16. The rotating device manufacturing method according to claim 13, wherein:
the cleaning step comprises:
a first contact step for causing the work-piece blown by the grains to be in contact with a first cleaning fluid; and
a second contact step for allowing the work-piece caused to be in contact with the first cleaning fluid to be further in contact with a second cleaning fluid; and
the second contact step is performed in a clean room with a higher cleanness than an atmosphere of the first contact step.

17. The rotating device manufacturing method according to claim 13, wherein:
the cleaning step comprises an ultrasound applying step for applying ultrasound to the work-piece from an ultrasound generator with the work-piece being dipped in the cleaning fluid in a cleaning bath; and
the ultrasound applying step adjusts, using a fluid level adjuster that adjusts a position of a fluid level of the cleaning fluid within a predetermined range, a vertical distance between the ultrasound generator and the fluid level so as to accomplish an ultrasound power density in the cleaning fluid that is equal to or greater than 10 (W/L) where the ultrasound power density is a ratio between an ultrasound output (Watt) and a volume (Liter) of the cleaning fluid.

18. The rotating device manufacturing method according to claim 13, further comprising a collecting step for collecting the blown grains to the work-piece.

19. A method for manufacturing a rotating device, the rotating device comprising a hub on which a recording disk is to be mounted, and a base that supports the hub in a freely rotatable manner, when at least one of the base and the hub is referred to as a work-piece, the method comprising:
a forming step for forming a work-piece;
a blowing step for blowing the formed work-piece with solid grains that are formed of a softer material than the work-piece;
a cleaning step for cleaning the work-piece blown by the grains using a cleaning fluid;
an assembling step for assembling the rotating device using the cleaned work-piece; and
a collecting step for collecting the blown grains to the work-piece,
wherein the grains have a property of vaporizing in the cleaning step or being soluble with the cleaning fluid therein.

20. The rotating device manufacturing method according to claim 18, wherein:
the cleaning step comprises:
a first contact step for causing the work-piece blown by the grains to be in contact with a first cleaning fluid; and
a second contact step for allowing the work-piece caused to be in contact with the first cleaning fluid to be further in contact with a second cleaning fluid; and
the second contact step is performed in a clean room with a higher cleanness than an atmosphere of the first contact step.
